(19) United States
(12) Patent Application Publication
(10) Pub. No.: US 2010/0119730 A1
(43) Pub. Date: May 13, 2010

(54) APPARATUS AND METHOD FOR FORMING A THIN FILM ELECTRONIC DEVICE ON A THERMOFORMED POLYMERIC SUBSTRATE

(76) Inventors: Brian K. Nelson, Shoreview, MN (US); David L. Philips, White Bear Lake, MN (US); Donald J. McClure, Siren, WI (US); Daniel H. Carlson, Arden Hills, MN (US); James N. Dobbs, Woodbury, MN (US); Scott M. Schnobrich, Cottage Grove, MN (US); Daniel J. Theis, Mahtomedi, MN (US)

Correspondence Address: 3M INNOVATIVE PROPERTIES COMPANY, PO BOX 33427, ST. PAUL, MN, 55133-3427, US

(21) Appl. No.: 12/597,198

(22) PCT Filed: Jun. 5, 2008
(86) PCT No.: PCT/US08/65836

§ 371 Date: Oct. 23, 2009

Related U.S. Application Data
(60) Provisional application No. 60/946,617, filed on Jun. 27, 2007.

(51) Int. Cl. B05C 9/14; H05B 6/46

(52) U.S. Cl. 427/543; 118/46

(57) ABSTRACT

An apparatus and method for fabricating electronic devices on a polymeric substrate provide for positionally constraining a polymer substrate on a platen, and heating the constrained polymer substrate to at least a glass transition temperature of the polymer substrate. A heat processable ink is applied to the constrained polymer substrate to form at least a portion of a layer of an electronic device thereon.

### TECHNICAL FIELD

The present invention is related to an apparatus and method for fabricating an electronic device on a polymeric substrate using heat processable inks.

### BACKGROUND

Electronic device fabrication by conventional methods typically involves use of high resolution photolithography processes to form multilayer devices. These high-resolution processes require substantial investment in equipment to achieve precise layer-to-layer alignments on substrates that are relatively flat and rigid.

The processes and requirements of conventional photolithographic techniques are less successful when fabricating devices on flexible, stretchable substrates, especially when the substrate is a polymer. Fabrication of electronic devices, such as thin film transistors, on flexible substrates generally requires relaxed registration tolerance between device layers. In particular, polymer substrates may be prone to distortion, such as shrinkage and/or expansion, due to thermal processing, and/or to absorption or desorption of water or other solvents, making layer to layer alignment difficult using conventional fabrication techniques.

It is desirable to form electronic devices on substrates that are flexible or stretchable. It is also desirable to fabricate such devices using low-cost polymeric substrates that are subject to a significant degree of distortion during electronic device fabrication. The present invention fulfils these and other needs, and offers other advantages over the prior art.

### SUMMARY

Embodiments of the present invention are directed to an apparatus and method for fabricating an electronic device or devices on a polymeric substrate. According to various embodiments, fabrication methods of the present invention involve positionally constraining a polymer substrate on a platen, and heating the constrained polymer substrate to at least a glass transition temperature of the polymer substrate. A heat processable ink is applied to the constrained polymer substrate to form at least a portion of a layer of an electronic device thereon.

Other embodiments of the present invention involve positionally constraining a polymer substrate on a platen, applying a heat processable ink to the constrained polymer substrate while the polymer substrate is at a temperature below a glass transition temperature of the polymer substrate, and heating the constrained polymer substrate with the heat processable ink to at least a glass transition temperature of the polymer substrate to form at least a portion of a layer of an electronic device thereon.

Embodiments of the present invention involve positionally constraining a polymer substrate on a platen and heating the constrained polymer substrate to a temperature lower than, but near, a glass transition temperature of the polymer. A heat processable ink is applied to the constrained polymer substrate while at this temperature. The constrained polymer substrate with the heat processable ink is heated to at least a glass transition temperature of the polymer substrate to form at least a portion of a layer of an electronic device thereon.

According to other embodiments of the present invention, apparatuses for forming at least a portion of an electronic device on a polymer substrate include a platen configured to receive the polymer substrate, and an arrangement configured to constrain the polymer substrate on the platen. A heat source is provided to heat the constrained polymer substrate to at least a glass transition temperature of the polymer substrate. A printer is configured to apply a heat processable ink to the constrained polymer substrate to form at least a portion of a layer of the electronic device thereon.

In some embodiments, the printer is configured to apply the heat processable ink to the constrained polymer substrate while the polymer substrates is at a temperature below a glass transition temperature of the polymer substrate. The constrained polymer substrate with the heat processable ink is heated by the heat source to at least a glass transition temperature of the polymer substrate to form at least a portion of a layer of an electronic device thereon.

In other embodiments, a heat source is provided to heat the constrained polymer substrate to a temperature lower than, but near, a glass transition temperature of the polymer substrate, and the printer is configured to apply the heat processable ink to the constrained polymer substrate while at this temperature. The same or different heat source is provided to heat the constrained polymer substrate with the heat processable ink to at least a glass transition temperature of the polymer substrate to form at least a portion of a layer of an electronic device thereon.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### DESCRIPTION OF THE DRAWINGS

FIG. 1 is a flow diagram showing various processes for forming electronic devices on a polymer substrate in accordance with embodiments of the present invention;

FIG. 2 is a diagram of an apparatus for forming electronic devices on a polymer substrate in accordance with embodiments of the present invention;

FIG. 3 is a diagram of a platen and an arrangement for heating a polymer substrate constrained on the platen in accordance with embodiments of the present invention;

FIG. 4A is a diagram of a curved structure of a platen that facilitates thermoforming of a polymer substrate constrained on the platen in accordance with embodiments of the present invention;

FIGS. 4B and 4C show structured elements or features that may be incorporated into a platen in accordance with embodiments of the present invention;

FIG. 5 is a diagram of an arrangement for constraining a polymer substrate on a platen in accordance with embodiments of the present invention.

FIG. 6 is a diagram of an arrangement for constraining a polymer substrate on a platen in accordance with other embodiments of the present invention.

FIG. 7 is a diagram of an arrangement for constraining a polymer substrate on a platen in accordance with further embodiments of the present invention; and

FIG. 8 is a diagram of an apparatus for forming electronic devices on a polymer substrate in accordance with embodiments of the present invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description of the illustrated embodiments, reference is made to the accompanying drawings that form a part hereof, and in which are shown by way of illustration, various embodiments in which the invention may be practiced. It is to be understood that the embodiments may be utilized and structural changes may be made without departing from the scope of the present invention.

The present invention is directed to fabricating electronic devices and, more particularly, to fabrication techniques and apparatuses that use heat processable inks applied to a polymer substrate to form an electronic device thereon. According to embodiments of the present invention, a polymer substrate is positionally constrained and subject to heating to at least a glass transition temperature of the polymer substrate, but preferably below the melting temperature of the substrate. Heat processable inks are applied to the positionally constrained polymer substrate to form one or more layers that define an electronic device or a portion thereof. The layers of the electronic device formed on the polymer substrate may include one or more of an electrically conductive layer, an electrically non-conductive layer, and a semiconductor layer, for example.

Conventional fabrication techniques, in contrast, typically limit heating of a polymer substrate to a temperature below the glass transition temperature of the substrate. When the glass transition temperature is reached or exceeded, the substrate suffers distortion typically due to shrinkage. For example, heating an unconstrained polymeric film to temperatures at or exceeding the glass transition temperature will cause the film material to become substantially non-planar due to thermal shrinkage.

Since polymer substrate distortion occurs during the sintering of a first layer printed on the substrate using conventional techniques, subsequent layers require positional adjustment to ensure proper registration that accounts for substrate shrinkage. Positional adjustments made to the substrate between fabrication phases introduces registration errors. Properly repositioning the heated polymer substrate to ensure proper registration for building additional electronic device layers is further complicated when substrate shrinkage is not uniform in both X and Y directions. Biaxial oriented films, for example, exhibit different shrinkage in the X and Y direction.

Positionally constraining the polymer substrate according to the present invention provides for forming of a multiplicity of electronic device structures and layers on the polymer substrate without having to remove or disturb the polymer substrate from its positionally constrained configuration. Heating, printing, sintering, drying, and cooling processes, for example, may be conducted while the polymer substrate is constrained on a platen and without removing the substrate from the platen between these fabrication phases.

Positionally constraining the polymer substrate in accordance with the present invention advantageously facilitates application of heat processable inks to the polymer substrate at elevated temperatures, such as at or above a glass transition temperature of the polymer substrate. As such, low cost polymer films that typically have glass transition temperatures of less that 155° C. may readily be used. Sintering of heat processable inks, such as silver nanoparticle ink, is a time-temperature process. Higher processing temperatures achievable in accordance with the present invention sinter the ink faster than at lower processing temperatures associated with conventional fabrication approaches. It is understood that heat processable inks may be applied to the polymer substrate at a variety of process temperatures, below or above a glass transition temperature of the polymer substrate.

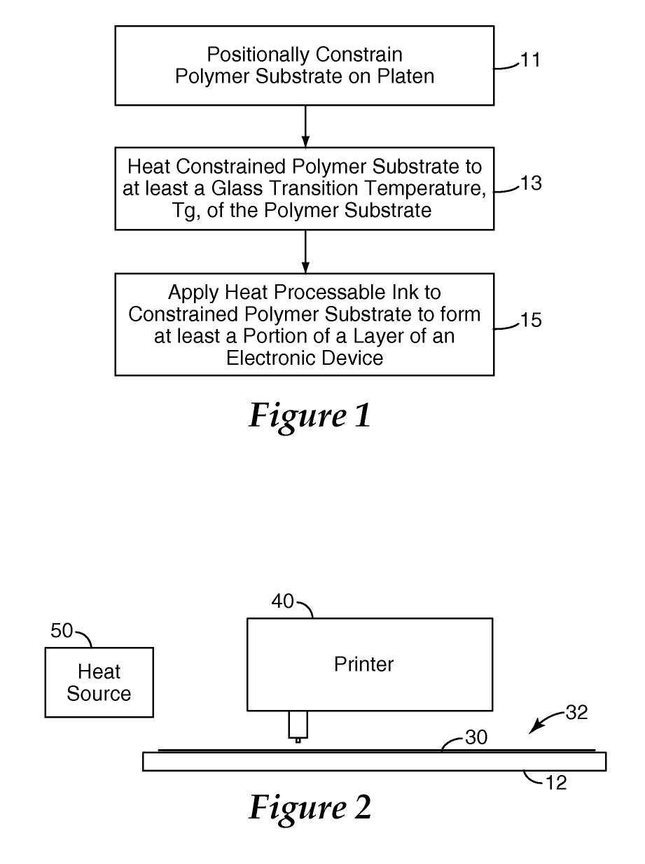

Turning now to FIG. 1, there is shown a flow diagram of various processes for forming electronic devices on a polymer substrate in accordance with embodiments of the present invention. According to FIG. 1, a polymer substrate is positionally constrained 11 on a platen. The constrained polymer substrate is heated 13 to at least a glass transition temperature of the polymer substrate. A heat processable ink is applied 15 to the constrained polymer substrate to form at least a portion of a layer of an electronic device thereon. Heating and constraining the polymer substrate according to embodiments of the present invention provides for thermoforming of the polymer substrate to assume a shape of the platen, which may be flat, curved shape, and/or include one or more structured elements or features.

Positionally constraining 11 the polymer substrate may involve producing a vacuum or an electrostatic charge to positionally constrain the polymer substrate on the platen. Positionally constraining 11 the polymer substrate may involve mechanically constraining the polymer substrate on the platen. A curved platen may be particularly advantageous to facilitate mechanical clamping.

Heating 13 the constrained polymer substrate may involve infrared heating of the constrained polymer substrate. According to one approach, the polymer substrate may be positionally constrained 11 on a heat absorptive structure of the platen that is thermally insulated from other portions of the platen, and heating 13 the constrained polymer substrate may involve heating the heat absorptive structure of the platen to at least a glass transition temperature of the substrate while other portions of the platen are at a temperature below the glass transition temperature, such as ambient temperature. According to other approaches, the platen structure may be heated using a suitable heat source (e.g., oven heated or integral electrical or fluidic heating elements), and need not include a separate or integral heat absorptive structure.

One or more additional heat processable inks may be applied to the constrained polymer substrate without removal of the polymer substrate from the platen to form at least a portion of one or more additional layers of the electronic device thereon. The heat processable inks preferably include inks that comprise electrically conductive particles or electrically non-conductive particles. For example, a suitable heat processable ink is a silver nanoparticle ink. The heat processable ink or inks applied to the polymer substrate may be subject to a drying process while the polymer substrate is positionally constrained on the platen.

Other embodiments of the present invention involve positionally constraining a polymer substrate on a platen, applying a heat processable ink to the constrained polymer substrate while the polymer substrate is at a temperature below a glass transition temperature of the polymer substrate, and heating the constrained polymer substrate with the heat processable ink to at least a glass transition temperature of the polymer substrate to form at least a portion of a layer of an electronic device thereon. Further embodiments of the present invention involve positionally constraining a polymer substrate on a platen and heating the constrained polymer substrate to a temperature lower than, but near, a glass transition temperature of the polymer. A heat processable ink is applied to the constrained polymer substrate while at this temperature. The constrained polymer substrate with the heat processable ink is heated to at least a glass transition temperature of the polymer substrate to form at least a portion of a layer of an electronic device thereon.

FIG. 2 is a diagram of an apparatus for forming electronic devices on a polymer substrate in accordance with embodiments of the present invention. The apparatus shown in FIG. 2 includes a platen 12 configured to receive the polymer substrate 30. The platen 12 may be substantially flat. The platen 12 may also be curved, and may include a simple or complex curve (e.g., single or multiple deflection points). The platen 12 may include one or more structured elements. Structured elements of the platen 12 may include non-planer shapes that impart functionality to the thin film electronic device, such as a mechanical tactile function for an electronic keypad. Alternatively, structured elements may aid further processing of the device with surface features that enhance traction, assisting the formation of a vacuum or enabling handling or packaging or the device.

An arrangement 32 is configured to constrain the polymer substrate 30 on the platen 12. A heat source 50 is configured to heat the constrained polymer substrate 30 to at least a glass transition temperature of the polymer substrate. A printer 40 is configured to apply heat processable ink to the constrained polymer substrate 30 to form at least a portion of a layer of the electronic device thereon.

In some embodiments, the heat source 50 is configured to heat the constrained polymer substrate 30 to a temperature below a glass transition temperature of the polymer substrate 30, and the printer 40 is configured to apply the heat processable ink to the constrained polymer substrate 30 while at this temperature. The constrained polymer substrate 30 with the heat processable ink is heated by the heat source 50 (or other heat source) to at least a glass transition temperature of the polymer substrate 30 to form at least a portion of a layer of an electronic device thereon.

In other embodiments, the heat source 50 is provided to heat the constrained polymer substrate 30 to a temperature lower than, but near, a glass transition temperature of the polymer substrate 30, and the printer 40 is configured to apply the heat processable ink to the constrained polymer substrate 30 while at this temperature. The same or different heat source 50 is provided to heat the constrained polymer substrate 30 with the heat processable ink to at least a glass transition temperature of the polymer substrate 30 to form at least a portion of a layer of an electronic device thereon.

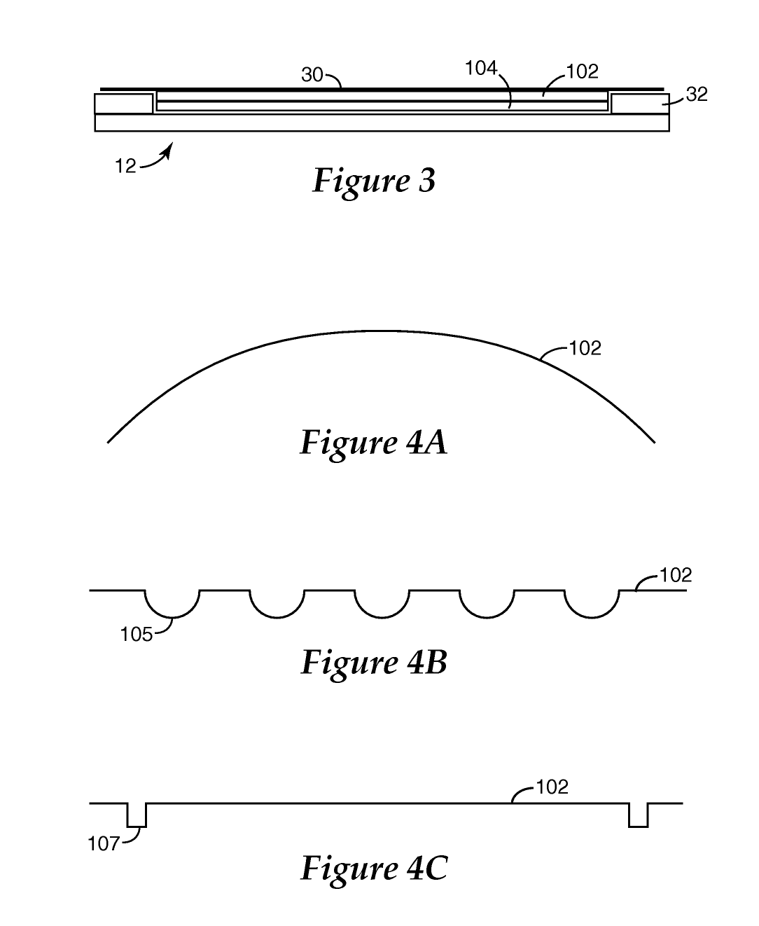

FIG. 3 illustrates an arrangement for heating a polymer substrate 30 constrained on the platen 12 in accordance with embodiments of the present invention. In general, the arrangement shown in FIG. 3 allows a thin film polymer substrate to be heated to a high temperature quickly, while constraining the shape of the polymer substrate as the temperature of the substrate reaches and exceeds the glass transition temperature, T_{g}, of the substrate. The arrangement of FIG. 3 provides a structure that dictates and controls the shape of the polymer substrate 30.

According the arrangement shown in FIG. 3, a platen 12 supports a heat absorptive structure 102 configured to receive a polymer substrate. A thermal insulator 104 is preferably disposed between the heat absorptive structure 102 and the supporting surface of the platen 12. The thermal insulator 104 may be formed from a variety of thermally insulating materials, such as rubber, plastic foam, ceramic materials, fiberglass or wood. The platen 12 further includes an arrangement 32 configured positionally constrain the polymer substrate 30 on the heat absorptive structure 102 of the platen 12.

Although shown substantially flat, the heat absorptive structure 102 and, preferably, the thermal insulator 104 may be curved, as is shown in FIG. 4A (e.g., convex or concave). The curve imparted to the heat absorptive structure 102 and thermal insulator 104 may be simple (e.g., a single point of deflection) or complex (e.g., multiple points of deflection). FIGS. 4B and 4C show a heat absorptive structure 102 that incorporates one or more structured elements. The heat absorptive structure 102 shown in FIG. 4B, for example, incorporates a series of dimples or depressions 105 that may impart functionality to the thin film electronic device, as discussed previously. FIG. 4C shows a heat absorptive structure 102 that incorporates grooves 107 that may facilitate or enhance positional constraining of the edge of the substrate during thermoforming and other fabrication processes, for example.

According to various embodiments, the heat absorptive structure 102 may include an infrared (IR) absorber or other heat absorptive structure or material having a low coefficient of thermal expansion (e.g., quartz with a backside coating of carbon black). Use of a heat absorptive material having a low coefficient of thermal expansion is desirable, so that thermal shrinkage of the polymer substrate 30 will be minimized. The surface of the heat absorptive structure 102 adjacent the thermal insulator 104 may be coated with carbon to enhance the absorption of IR energy, for example. Inclusion of the thermal insulator 104 reduces conduction of thermal energy away from the heat absorptive structure 102. When IR radiation is present, the polymer substrate material 30 softens. A constraining force is applied to the heated polymer substrate 30 vis-à-vis the constraining arrangement 32 so that the substrate 30 takes the shape of the heat absorptive structure 102.

Infrared sintering of heat processable inks, such as silver nanoparticle inks, can now take place at temperatures that exceed the glass transition temperature, T_{g}, of the polymer substrate material 30. When cooled, the polymer substrate material 30 retains the shape of the heat absorptive structure 102 and, preferably, the constraining arrangement 32, since both structures as shown in the embodiment of FIG. 3 are substantially smooth and planer. The non-planer area of the polymer substrate 30 can be trimmed and recycled.

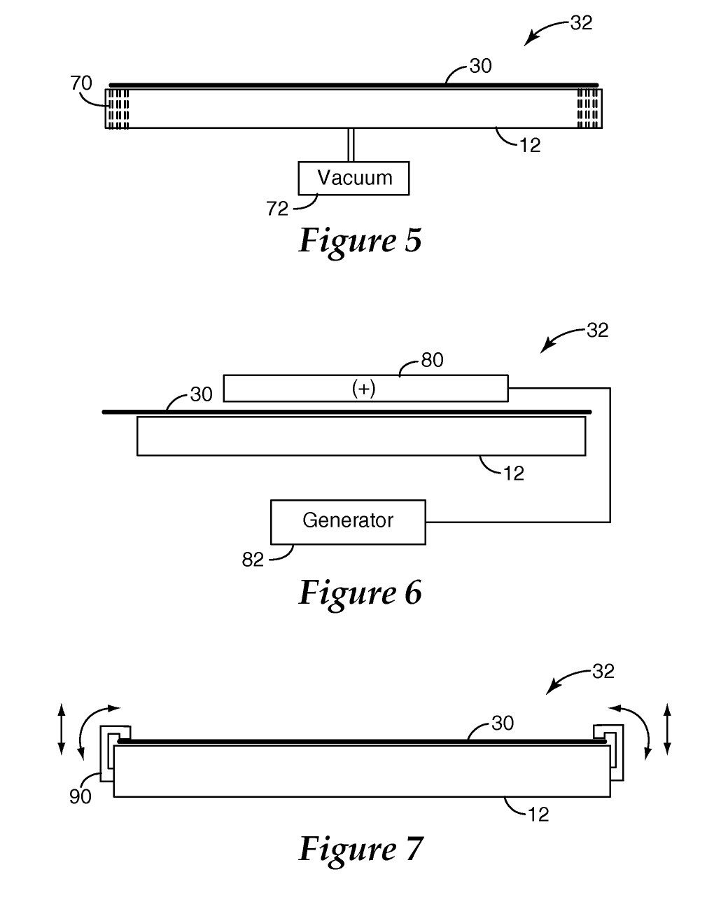

FIG. 5 is a diagram of an arrangement for constraining a polymer substrate on a platen in accordance with embodiments of the present invention. The constraining arrangement 32 shown in FIG. 5 includes a porous metal (e.g., aluminum) platen 12. For example, the platen 12 may include perforations 70 or pores distributed through the platen 12. The perforations 70 may be situated at various locations of the platen 12, but are typically disposed proximate a peripheral edge of the platen 12.

A vacuum source 72 is fluidly coupled to the perforation 70. When the vacuum source 72 is turned on, a negative pressure condition is created at the surface of the platen 12 proximate the perforations 70. When a polymer substrate 30 is situated on the platen 12 such that portions of the substrate 30 cover, or are immediately proximate to, the perforations 70, the negative pressure condition provides a constraining force that positionally restrains the polymer substrate 30 on the platen 12. After processing of the polymer substrate 30, the vacuum 72 is removed or a positive pressure is generated to facilitate removal of the polymer substrate 30 from the platen 12.

FIG. 6 is a diagram of an arrangement for constraining a polymer substrate on a platen in accordance with other embodiments of the present invention. According to the configuration shown in FIG. 6, an electrostatic pinning arrangement 32 is employed to positionally constrain a polymer substrate 30 on a platen 12. The constraining arrangement 32 of FIG. 6 includes the platen 12 coupled to ground and a positive electrode 80 coupled to a generator 82 that typically includes a voltage control.

Application of a voltage potential between the electrodes 80 and the grounded platen 12 by the generator 82 creates an electrostatic field, the strength of which may be adjusted by the voltage control. When the polymer substrate 30 is situated on the platen 12 and the generator 82 is active, the electrostatic field creates a surface charge imbalance between the platen 12 and the polymer substrate 30. The surface charge imbalance results in attractive forces that positionally constrain the substrate 30 on the platen 12. Deactivation of the generator 82 after processing facilitates removal of the polymer substrate 12 from the platen 12.

FIG. 7 is a diagram of an arrangement for constraining a polymer substrate on a platen in accordance with further embodiments of the present invention. According to the configuration shown in FIG. 7, a mechanical constraining arrangement 32 provides for positionally constraining a polymer substrate 30 on a platen 12. A retention apparatus 90 provides for mechanical engagement between the retention apparatus and edge portions of the polymer substrate 30. Engagement between the retention apparatus 90 and the edge portions of the polymer substrate 30 results a compressive force that constrains the substrate 30 to the platen 12.

A variety of mechanical arrangements are contemplated. For example, the retention apparatus 90 may include a number of edge members that are configured to engage at least a portion of a number peripheral edge portions of the polymer substrate 30. In some configurations, the edge members of the retention apparatus 90 may pivot or rotate in and out of engagement with the polymer substrate 30. In other configurations, the edge members of the retention apparatus 90 may be movable in a plane normal to the plane of the polymer substrate 30, and engage the polymer substrate 30 by raising and lowering the edge members. Movement of the retention apparatus 90 may be computer controlled or effected manually. Individual edge members may be movable independent of, or in concert with, one another.

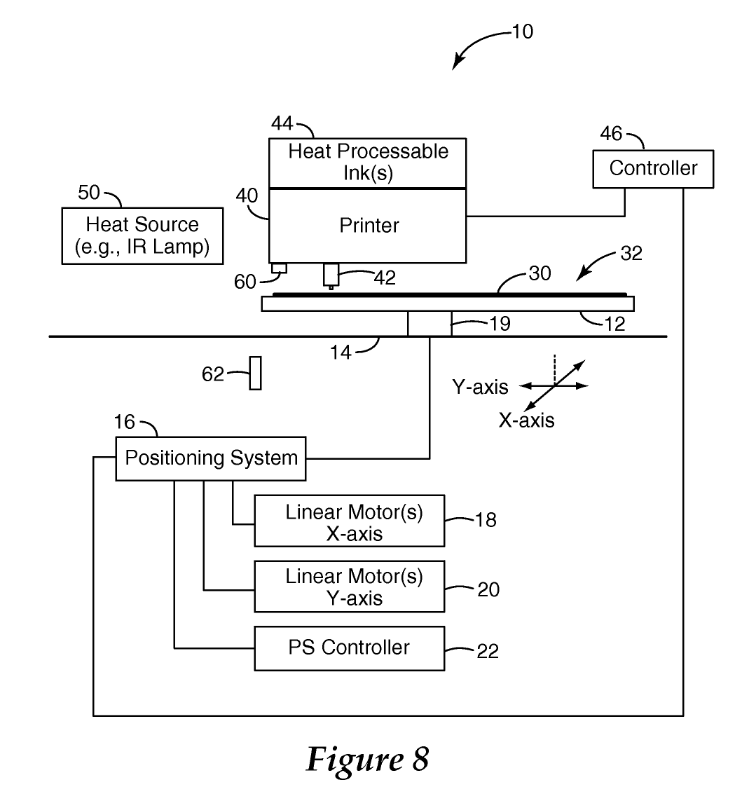

FIG. 8 is a diagram of an apparatus for forming electronic devices on a polymer substrate in accordance with embodiments of the present invention. The apparatus shown in FIG. 8 includes a platen 12 and a constraining arrangement 32 of a type previously described. A polymer substrate 30 is shown constrained on the platen 12. A platen support 19 extends from the platen 12 and is coupled to a positioning system 16. The positioning system 16 facilitates movement of the platen support 19 and, therefore, platen 12 in a multiplicity of directions, including along an x-axis and a y-axis as shown in FIG. 8.

The positioning system 16 may include a motorized linear positioning table 14 and two or more motors 18, 20 arranged for moving the platen 12 in an x-direction and a y-direction. Other motors may be arranged for moving the platen 12 in a z-direction if desired. The positioning system 16, which may include a controller 22, is preferably coupled to a system controller 46. A suitable linear motor 20 for moving the platen 12 along the y-axis is Trilogy Linear Motor Model T3DS43-2NCJS. A suitable linear motor 18 for moving the platen 12 along the x-axis is Trilogy Linear Motor Model T2DS43-2NCJS. A suitable motorized linear positioning table 14 is Parker Daedal Model 500000ET. A suitable positioning system controller 22 is a Delta Tau UMAC position controller.

A printer 40 is shown situated above the platen 12. The printer 40 includes a printhead 42 that is shown positioned proximate a polymer substrate 30 that is positionally constrained on the platen 12. The printer 40 is configured to apply heat processable inks 44 to the polymer substrate 30, such as inks that include electrically conductive particles and those that include electrically non-conductive particles. Suitable printers 40 include various inkjet printers, such as those that employ a piezoelectric inkjet head and support electronics. One such printer 40 is a Spectra SE-128 jetting assembly, which provides for 128 individually addressable inline nozzles and a 30 picoliter drop volume.

The positioning system 16 may be aided by one or more cameras that facilitate registration of the platen 12 relative to the printhead 42. One or more cameras may be deployed to provide a camera-based registration system. A suitable vision-based registration system is the Legend 530 Machine Vision Sensor System, available from DVT Corporation. In the configuration shown in FIG. 8, one camera 60 is situated on the same linear axis as the printhead 42. Another camera 62 may be situated at a fixed position relative to the platen 12.

A heat source 50 is situated proximate the printer 40. The heat source 50 is preferably an IR heat source, such as an IR lamp that can focus high intensity infrared energy on specific target areas (e.g., using an elliptical reflector). A suitable IR heat source is Model IR 5194-04 (4 inch, 2000 W IR lamp) available from Research Inc. of Eden Prairie, Minn., which is powered by a Research Incorporated 5420 ma Power controller. An optional ultraviolet lamp (not shown) may also be included, such as a 254 nm “germicidal” UV lamp.

The system controller 46 is communicatively coupled to the printer 40, positioning system 16, and cameras 60, 62. The system controller 46 executes programmed instructions for fabricating electronic device structures on the polymer substrate 30 in accordance with the present invention.

For example, the system controller 46 coordinates movement of the platen 12 along the y-axis so as to position the polymer substrate 30 under the printer 40 and under the heat source 50 in accordance with the programmed instructions. In accordance with a preferred fabrication approach, the polymer substrate 30 is situated on the platen 12, and the constraining arrangement 32 is activated. Placement of the polymer substrate 30 onto and from the platen 12 may be effected manually or by use of a computer controlled pick-and-place machine as is known in the art. With the polymer substrate 30 constrained on the platen 12, the platen 12 is moved under the heat source 50.

The temperature of the polymer substrate 30 is preferably raised to at least the glass transition temperature of the polymer substrate 30 and, more preferably, above T_{g} of the polymer substrate 30. As previously discussed, the platen 12 may include a heat absorptive structure that is thermally insulated from other portions of the platen 12, thereby allowing for rapid heating of the polymer substrate 30 to the desired processing temperature, while other portions of the platen 12 remain at ambient temperature. After heating the polymer substrate 30 to at least T_{g}, the platen 12 is moved underneath the printer 40, and heat processable inks are applied to the constrained polymer substrate 30 to form at least a portion of one or more layers of an electronic device thereon. As was previously discussed, heat processable inks may be applied to the constrained polymer substrate 30 while heated at a temperature lower than T_{g} (e.g., near T_{g}) and the constrained polymer substrate 30 with the heat processable inks may subsequently be heated at a temperature of at least T_{g}.

The apparatus shown in FIG. 8 may be controlled to implement a sub-process of a process of fabricating thin film electronic devices components by drop on demand printing. In particular, the apparatus of FIG. 8 may be controlled to implement a sub-process of sintering metallic nanoparticles on a thermoformed polymeric substrate, such as sintering silver nanoparticle inks to form conductive circuits on a thermoformed polymeric substrate.

The system of FIG. 8 may be used to fabricate electronic devices via deposition of liquids via an inkjet printhead in patterns that define each of the layers of the device. In the following discussion, an illustrative process of building a bottom gate, bottom contact thin film transistor (TFT) using the system of FIG. 8 is described. It is understood that other devices may be fabricated with this system and processes, and that the some of the described processes may be excluded and others included. In the process flow described below, it is assumed that all material solutions and image files are already prepared. The image files may contain features needed for multiple devices.

Processes for building an all-additive TFT from solution according to this non-limiting illustrative example include the following:
1. Situate polymer substrate 30 on the platen 12.
2. Clean the substrate surface.
3. Register the position of the lower left corner of the substrate 30 with Camera 60.
4. Deposit the Gate Layer.
   4.1. Preheat and thermoform the substrate 30 using heat source 50 and constraining arrangement 32 (via vacuum, electrostatic pinning or mechanically).
   4.2. Re-register the position of the lower left corner of the substrate 30 with Camera 60.
   4.3. Inkjet print the gate layer using printer 40.
   4.4. Measure and record the overall size of the printed image.
   4.5. Dry and sinter the Silver (Ag) gate layer.
5. Deposit the Dielectric Layer.
6. Deposit the Source-Drain Layer.
7. Deposit the Semiconductor Layer.
8. Remove substrate 30 and electronic device formed thereon from the platen 12.

The apparatus shown in FIG. 8 was used to perform several experiments, various processes of which are described below. Polymer substrates used in the experiments included PEN and PET films. The PEN film used in the experiments was PEN film Q65F 5 mil A5072, available from Teijin DuPont Films. The PET films used in the experiments were PET film-1 (2 mil PET) and PET film-2 (5 mil ST504 PET). The heat processable ink used in the experiments was Silver Ink AG-IJ-G-100-S1, available from Cabot Corporation.

The platen 12 was of a construction shown in FIG. 3, having a quartz glass plate with a backside coating of carbon black and a thermal insulator (e.g., pine wood). A porous aluminum platen 12 was constructed to facilitate the use of vacuum to constrain the substrate. The polymer substrate 30 was placed on the platen 12 and a vacuum was created to positionally constrain the substrate 30 on the platen 12. The substrate 30 was heated to a temperature at or above the glass transition temperature of the substrate 30 using an IR lamp 50 by way of four passes at 2″/second, 100% power (1″ advance per pass).

The constrained substrate 30 was moved under the printer 40. An image was printed on the substrate 30 using the following settings:
i) Horizontal Pixel Increment 11 or Saber angle 5.19 degrees
ii) Pulse Amplitude 100V
iii) Fire pulse width 5 μSeconds
iv) Rise and fall time 1.5 μSeconds
v) Velocity 2″/sec
vi) Acceleration 4″/Seĉ2
vii) Meniscus vacuum 5 to 6 inches H2O.

After printing, the silver nanoparticle ink was sintered using the IR lamp 50 by way of 8 passes at 2″/second, 100% power. (1/2″ advance/pass). Following sintering, the substrate 30 was removed from the platen 12 for visual inspection and to measure electrical properties of the printed image.

Experiments using the PEN, PET film-1, and PET film-2 substrates 30 demonstrated that the substrates 30 took on the shape of the platen 12 and that silver ink was fully dried. Electrical measurements revealed very good electrical characteristics for the printed structures.

Fabricating electronic devices on thin film polymeric substrates in accordance with the present invention provides several advantages over conventional fabrication approaches. For example, thermoforming a polymer substrate to a planar (flat or curved) surface allows process temperatures that exceed the glass transition temperature of the substrate to be utilized to sinter heat processable inks, such as silver nanoparticle ink. Using a platen or mold that can heat quickly by IR radiation results in substantially shorter cure times. Better conductivities are achievable when the ink transforms from a wet blue film to a dry silver film at a higher process temperature (e.g., temperatures at or above T_{g} of the polymer substrate). Substrate shrinkage is reduced since the substrate is thermoformed to a quartz sheet, for example, of the platen. The substrate need not be removed from the platen between processing phases, thereby reducing or eliminating re-alignment errors associated with conventional fabrication approaches.

The foregoing description of the various embodiments of the invention has been presented for the purposes of illustration and description. It is not intended to be exhaustive or to limit the invention to the precise form disclosed. Many modifications and variations are possible in light of the above teaching. For example, embodiments of the present invention may be implemented in a wide variety of applications. It is intended that the scope of the invention be limited not by this detailed description, but rather by the claims appended hereto.

1. A method, comprising:
positionally constraining a polymer substrate on a platen comprising (1) a heat absorber having a first surface and a second surface, the first surface of the heat absorber configured to receive the polymer substrate and (2) an insulator having a first surface and a second surface, the first surface of the insulator in planar contact with the second surface of the heat absorber;
heating the constrained polymer substrate to at least a glass transition temperature of the polymer substrate, wherein heating the constrained polymer substrate comprises heating the absorptive structure of the platen to at least the glass transition temperature while other portions of the platen are at a temperature below the glass transition temperature; and
applying a heat processable ink to the constrained polymer substrate to form at least a portion of a layer of an electronic device thereon.

2. The method of claim 1, wherein positionally constraining the polymer substrate comprises producing a vacuum or an electrostatic charge to positionally constrain the polymer substrate on the platen, or mechanically constraining the polymer substrate on the platen.

3. The method of claim 1, wherein heating the constrained polymer substrate comprises infrared heating of the constrained polymer substrate.

4. (canceled)

5. The method of claim 1, wherein constraining and heating the polymer substrate comprises thermoforming the polymer substrate to assume a shape of the platen.

6. The method of claim 1, wherein the heat processable ink comprises electrically conductive particles or electrically non-conductive particles.

7. The method of claim 1, wherein the heat processable ink comprises a silver nanoparticle ink.

8. The method of claim 1, comprising applying one or more additional heat processable inks to the constrained polymer substrate without removal of the polymer substrate from the platen to form at least a portion of one or more additional layers of the electronic device thereon.

9. The method of claim 1, comprising applying one or more additional heat processable inks to the constrained polymer substrate to form at least a portion of one or more additional layers of the electronic device thereon.

10. The method of claim 1, wherein the layers of the electronic device formed on the polymer substrate comprise at least two of an electrically conductive layer, an electrically non-conductive layer, and a semiconductor layer.

11. An apparatus for forming at least a portion of an electronic device on a polymer substrate, comprising:
a platen configured to receive the polymer substrate, wherein the platen comprises (1) a heat absorber having a first surface and a second surface, the first surface of the heat absorber configured to receive the polymer substrate and (2) an insulator having a first surface and a second surface, the first surface of the insulator in planar contact with the second surface of the heat absorber;
an arrangement configured to constrain the polymer substrate on the platen;
a heat source configured to heat the constrained polymer substrate to at least a glass transition temperature of the polymer substrate; and
a printer configured to apply a heat processable ink to the constrained polymer substrate to form at least a portion of a layer of the electronic device thereon.

12. The apparatus of claim 11, wherein the constraining arrangement comprises a vacuum source fluidly coupled to the platen.

13. The apparatus of claim 11, wherein the constraining arrangement comprises an electrostatic pinning arrangement.

14. The apparatus of claim 11, wherein the constraining arrangement comprises a mechanical arrangement configured to positionally constrain the polymer substrate on the platen.

15. The apparatus of claim 11, wherein the heat source comprises an infrared heat source.

16. The apparatus of claim 11, wherein the printer comprises an inkjet printer.

17. (canceled)

18. The apparatus of claim 11, wherein the heat absorber comprises an infrared heat absorptive material.

19. The apparatus of claim 11, wherein the platen is substantially flat or comprises a curve.

20. The apparatus of claim 11, wherein the platen comprises one or more structured elements.

21. The apparatus of claim 11, wherein the heat processable ink comprises electrically conductive particles or electrically non-conductive particles.

22. The apparatus of claim 11, wherein the heat processable ink comprises a silver nanoparticle ink.

23. (canceled)

24. (canceled)
